(19) United States
(12) Patent Application Publication
(10) Pub. No.: US 2013/0311624 A1
(43) Pub. Date: Nov. 21, 2013

(54) METHOD, APPARATUS AND SYSTEM FOR CONFIGURING IP ADDRESS

(71) Applicant: Huawei Technologies Co., Ltd., Shenzhen (CN)

(72) Inventors: Bing LIU, Beijing (CN); Sheng Jiang, Beijing (CN)

(73) Assignee: HUAWEI TECHNOLOGIES CO., LTD., Shenzhen (CN)

(21) Appl. No.: 13/951,709

(22) Filed: Jul. 26, 2013

Related U.S. Application Data
(63) Continuation of application No. PCT/CN2012/070311, filed on Jan. 13, 2012.

(30) Foreign Application Priority Data
Jan. 28, 2011 (CN) 201110032062.7

(51) Int. Cl. H04L 29/12

(52) U.S. Cl. CPC H04L 61/2015
USPC 709/221

(57) ABSTRACT

The present invention discloses a method, an apparatus and a system for configuring an IP address to solve a problem that in the process of network renumbering, when a conflict occurs between address configuration policies of a host, adopting a local policy of the host may cause an adverse impact on a network. In the present invention, when an address configuration policy conflict occurs, a terminal reports address configuration policy conflict information to a network side, so that the address configuration policy conflict in the terminal is no longer processed by a local policy of the terminal, but processed by the network side, that is, the network side decides what address configuration policy is adopted for the terminal. Therefore, an optimal solution can be provided for the conflict according to the actual situation of the network, thereby preventing an adverse impact on the network caused by the conflict.

### CROSS-REFERENCE TO RELATED APPLICATIONS

This application is a continuation of International Application No. PCT/CN2012/070311, filed on Jan. 13, 2012, which claims priority to Chinese Patent Application No. 201110032062.7, filed on Jan. 28, 2011, both of which are hereby incorporated by reference in their entireties.

### FIELD OF THE INVENTION

The present invention relates to the field of data transmission technologies, and in particular, to a method, an apparatus and a system for configuring an IP address.

### BACKGROUND OF THE INVENTION

Network renumbering refers to reconfiguration of an IP address of a host in a network due to network reorganization, switching of an ISP (Internet Service Provider, internet service provider) and other reasons.

Renumbering in IPv6 (Internet Protocol Version 6, Internet Protocol version 6) is generally performed by switching an address prefix, namely, a network delivers a new address prefix and cancels a previously used address prefix. In the process of renumbering, three manners may be adopted to configure a new IP address for a host: adopting a DHCP (Dynamic Host Configuration Protocol, dynamic host configuration protocol) to perform stateful address configuration on the host; adopting an ND (Neighbor Discovery, neighbor discovery) protocol to perform stateless address configuration on the host; and manual configuration.

DHCPv6 is an IPv6 version of the DHCP, belonging to a stateful address auto-configuration protocol. In the process of stateful address configuration, a DHCP server may actively initiate a stateful address configuration message (a DHCP reconfiguration message) to a DHCP client to trigger reconfiguration; after receiving the DHCP reconfiguration message, the DHCP client selects, according to an instruction in the message, to send a renew (renew) message or an information-request (information-request) message to the DHCP server, so as to configure a new address. The configuration flow is shown in FIG. 1.

The ND protocol enables a node (a host and a router) to discover data link layer addresses of other neighbors on the current link, and uses five types of ICMPv6 (Internet Control Message Protocol Version 6, Internet Control Message Protocol version 6) data packets for work, including: router advertisement (RA, Router Advertisement), router solicit (RS, Router Solicit), neighbor solicit (NS, Neighbor Solicit), neighbor advertisement (NA, Neighbor Advertisement) and redirect (redirect).

After receiving an RS message periodically, the router uses an RA message to notify the host on the link of its existence, in which the RA message carries information such as a prefix used to perform address auto-configuration. In the process of renumbering, the router may use the RA message of the ND protocol to notify the host on the link of a new address prefix. After receiving the address prefix, the host may perform stateless address auto-configuration.

Usually, a network may be deployed with the DHCPv6 and ND protocols at the same time. In the network shown in FIG. 2, after triggering reconfiguration, the DHCP server may directly notify a host 4 of an address prefix through a DHCP reconfiguration message; the DHCP server may also allocate an address prefix to a DHCP address prefix proxy first, then the DHCP address prefix proxy allocates an address prefix to a DHCP relay, and the DHCP relay 12 notifies the host 4 of the address prefix through an RA message of the ND protocol subsequently. Therefore, the host 4 may receive address configuration messages of two different protocol types, namely, DHCPv6 and ND, at the same time or at different time.

In the process of implementing the network renumbering in the network deployed with the DHCPv6 and ND protocols at the same time, the inventors find that the prior art has at least the following problem. The ND protocol explicitly stipulates the practice of the host configured with ND when the host receives the RA message and is notified of the new address prefix, and the DHCP protocol also explicitly stipulates the practice of the host configured with DHCP when the host receives the DHCP reconfiguration message and is notified of the new address prefix. However, for the processing method in a case that a conflict between address configuration policies of the host occurs, namely, for the processing method in a case that the host configured with DHCP receives the RA message or the host configured with ND receives the DHCP reconfiguration message, there is no explicit definition on the level of standards.

At present, the processing method for the foregoing conflict is: performing processing according to a local policy configured by the operating system/protocol stack related programs of the host. Taking the host configured with DHCP receiving the RA message as an example, the local policy configured by the host is as follows.

1. According to the new address prefix of the RA message, abandon the DHCP configuration, and use the stateless address configuration.

2. If the host configured with DHCP also receives the DHCP reconfiguration message, perform reconfiguration negotiation with the DHCP server according to the new address prefix of the DHCP reconfiguration message.

3. Ignore the RA message, and if no DHCP reconfiguration message is received, still use the old address.

All the foregoing three cases of the local policy may cause an adverse impact on the network. For the first case, abandoning the DHCP configuration and using the stateless address configuration may violate the network policy of the DHCP server for unified management on the host, and easily cause management confusion. For the second case in which the new address prefix of the DHCP reconfiguration message is received, if the new address prefix delivered by the DHCP server is different from the new address prefix notified through the RA message due to factors such as a management mistake, the host cannot perform routing after an address is configured for the host according to the DHCP. For the third case, the host continues to use the old address, so that the network renumbering operation of the host fails.

Similarly, when the host configured with ND receives the DHCP reconfiguration message, adopting a local policy similar to the foregoing local policy may also cause an adverse impact on the network.

Therefore, in the process of network renumbering, when a conflict occurs between address configuration policies of the host, adopting the local policy of the host may cause an adverse impact on the network.

### SUMMARY OF THE INVENTION

Embodiments of the present invention provide a method, an apparatus and a system for configuring an IP address, which can prevent an adverse impact on a network caused by a conflict between address configuration policies of a host in the process of network renumbering.

To achieve the foregoing objectives, the embodiments of the present invention adopt the following technical solutions.

A method for configuring an IP address includes: receiving an address configuration message; when an address configuration policy conflict occurs, reporting address configuration policy conflict information to a network side; and receiving an address configuration instruction delivered by the network side.

A method for configuring an IP address includes: receiving address configuration policy conflict information reported by a terminal; and according to the address configuration policy conflict information, delivering an address configuration instruction to the terminal, or reporting information about an error to a network management system.

An apparatus for configuring an IP address includes: a message receiving module, configured to receive an address configuration message; a conflict reporting module, configured to, when an address configuration policy conflict occurs, report address configuration policy conflict information to a network side; and an instruction receiving module, configured to receive an address configuration instruction delivered by the network side.

An apparatus for configuring an IP address includes: a conflict receiving module, configured to receive address configuration policy conflict information reported by a terminal; a first sending module, configured to, according to the address configuration policy conflict information, deliver an address configuration instruction to the terminal, or report information about an error to a network management system.

A system for configuring an IP address includes: a terminal and a network side, in which the terminal is configured to, when an address configuration policy conflict occurs, report address configuration policy conflict information to the network side; and the network side is configured to, according to the address configuration policy conflict information, deliver an address configuration instruction to the terminal, or report information about an error to a network management system.

In the method, the apparatus and the system for configuring an IP address provided by the embodiments of the present invention, when an address configuration policy conflict occurs, a terminal reports address configuration policy conflict information to a network side, so that the address configuration policy conflict in the terminal is no longer processed by a local policy of the terminal, but processed by the network side, that is, the network side decides what address configuration policy is adopted for the terminal. Therefore, an optimal solution can be provided for the conflict according to the actual situation of a network, thereby preventing an adverse impact on the network caused by the conflict.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from these accompanying drawings without creative efforts.

FIG. 1 is a flow chart of performing stateful address configuration for a host configured with DHCP in the prior art;

FIG. 2 is a schematic diagram of performing network renumbering in a network deployed with DHCPv6 and ND protocols at the same time in the prior art;

FIG. 3 is a flow chart of a method for configuring an IP address according to Embodiment 1 of the present invention;

FIG. 4 is a block diagram of an apparatus for configuring an IP address according to Embodiment 1 of the present invention;

FIG. 5 is a flow chart of a method for configuring an IP address according to Embodiment 2 of the present invention;

FIG. 6 is a block diagram of an apparatus for configuring an IP address according to Embodiment 2 of the present invention;

FIG. 7 is a flow chart of a method for configuring an IP address according to Embodiment 3 of the present invention;

FIG. 8 is a flow chart of another method for configuring an IP address according to Embodiment 3 of the present invention;

FIG. 9 is a flow chart of still another method for configuring an IP address according to Embodiment 3 of the present invention;

FIG. 10 is a block diagram of an apparatus for configuring an IP address according to Embodiment 4 of the present invention; and

FIG. 11 is a block diagram of a system for configuring an IP address according to Embodiment 5 of the present invention.

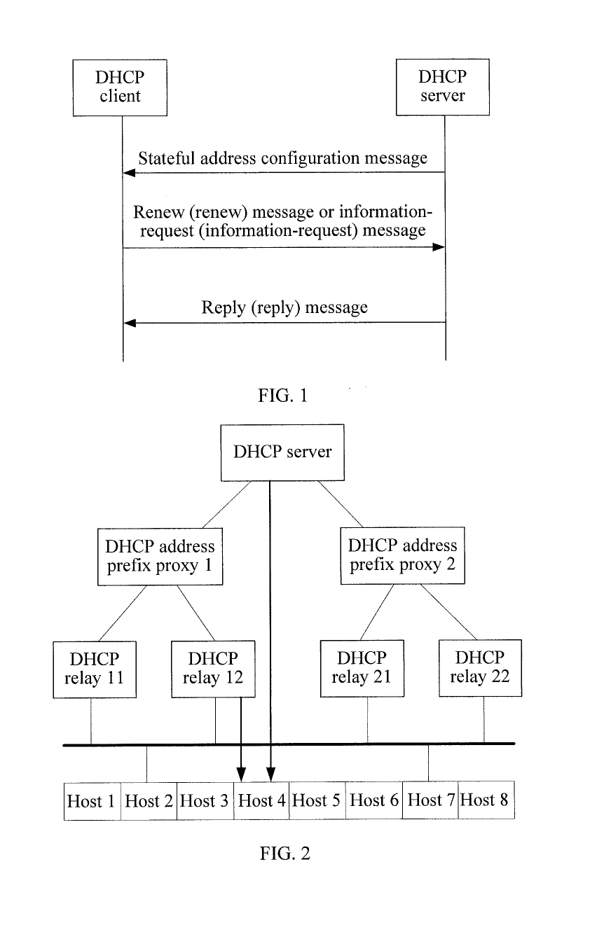

### DETAILED DESCRIPTION OF THE EMBODIMENTS

The following clearly and completely describes the technical solutions according to the embodiments of the present invention with reference to the accompanying drawings in the embodiments of the present invention. Apparently, the embodiments in the following description are merely a part rather than all of the embodiments of the present invention. All other embodiments obtained by persons of ordinary skill in the art based on the embodiments of the present invention without creative efforts shall fall within the protection scope of the present invention.

### Embodiment 1

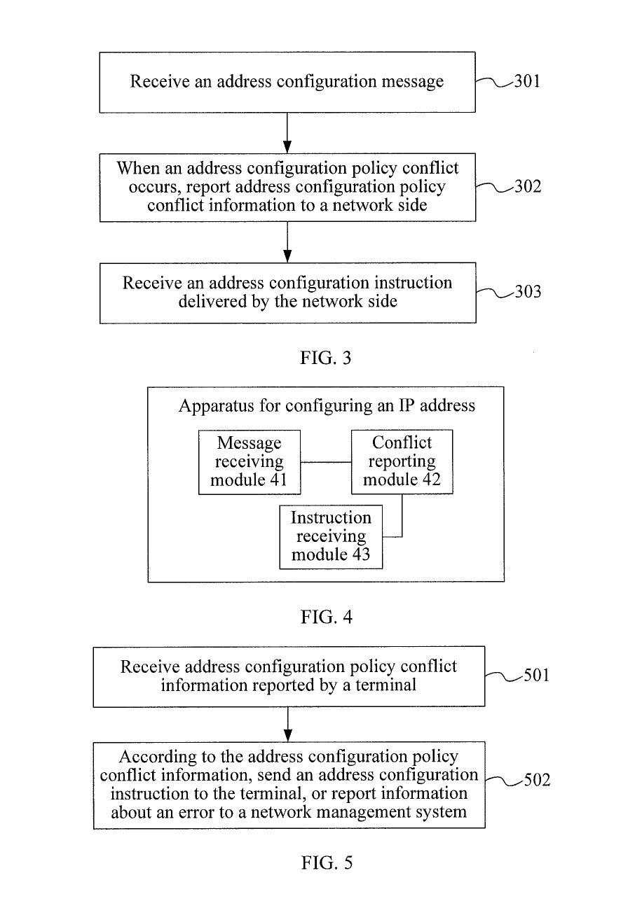

As shown in FIG. 3, a method for configuring an IP address includes the following steps.

301: Receive an address configuration message.

Specifically, when an IP address of a terminal in a network needs to be reconfigured, the terminal may receive address configuration messages sent by other nodes in the network. It is assumed that the terminal is a host configured with DHCP, and other nodes in the network include, but are not limited to, a DHCP server and a DHCP relay, the host may receive a stateful address configuration message sent by the DHCP server and/or a stateless address configuration message sent by the DHCP relay.

When the host configured with DHCP receives the stateless address configuration message from the DHCP relay, namely, an RA message, an address configuration policy conflict occurs in the host configured with DHCP.

302: When an address configuration policy conflict occurs, report address configuration policy conflict information to a network side.

Specifically, when an address configuration policy conflict occurs in the terminal, the terminal generates address configuration policy conflict information, and then reports the information to the network side. The network side may include, but not limited to, a DHCP server.

303: Receive an address configuration instruction delivered by the network side.

Specifically, when receiving the address configuration policy conflict information, the network side, for example, the DHCP server, generates an address configuration instruction according to the information, and then delivers the instruction to the terminal. Upon receiving the address configuration instruction, the terminal may complete modification of an IP address prefix according to a requirement of the instruction.

The execution subject of the foregoing steps may be a terminal, a host configured with DHCP, or another device that needs to be renumbered in a network.

In the method for configuring an IP address provided by the embodiment of the present invention, when an address configuration policy conflict occurs, a terminal reports address configuration policy conflict information to a network side, so that the address configuration policy conflict in the terminal is no longer processed by a local policy of the terminal, but processed by the network side, that is, the network side decides what address configuration policy is adopted for the terminal. Therefore, an optimal solution can be provided for the conflict according to the actual situation of a network, thereby preventing an adverse impact on the network caused by the conflict.

This embodiment further provides an apparatus for configuring an IP address. As shown in FIG. 4, the apparatus includes: a message receiving module 41, configured to receive an address configuration message; a conflict reporting module 42, configured to, when an address configuration policy conflict occurs, report address configuration policy conflict information to a network side; and an instruction receiving module 43, configured to receive an address configuration instruction delivered by the network side.

The method executed by the foregoing modules has been described in detail above, and details are not described herein again.

In the apparatus for configuring an IP address provided by this embodiment, through a conflict reporting module, when an address configuration policy conflict occurs, a terminal reports address configuration policy conflict information to a network side, so that the address configuration policy conflict in the terminal is no longer processed by a local policy of the terminal, but processed by the network side, that is, the network side decides what address configuration policy is adopted for the terminal. Therefore, an optimal solution can be provided for the conflict according to the actual situation of a network, thereby preventing an adverse impact on the network caused by the conflict.

### Embodiment 2

As shown in FIG. 5, another method for configuring an IP address includes the following steps.

501: Receive address configuration policy conflict information reported by a terminal.

Specifically, when an IP address of a terminal in a network needs to be reconfigured, an address configuration policy conflict may occur in the terminal. When the conflict occurs, the terminal may report address configuration policy conflict information to a network side.

502: According to the address configuration policy conflict information, send an address configuration instruction to the terminal, or report information about an error to a network management system.

Specifically, the network side may generate an address configuration instruction according to the address configuration policy conflict information reported by the terminal, and then deliver the instruction to the terminal. Upon receiving the address configuration instruction, the terminal may complete modification of an IP address prefix according to a requirement of the instruction.

Besides, when some special cases occur, for example, new address prefixes included in address configuration messages of different protocol types are different, which is caused by an error in a network, at this time, the network side may also report information about an error to the network management system according to the address configuration policy conflict information reported by the terminal. After receiving the information, the network management system may take a corresponding measure to correct the error in the network, and performs correct address configuration on the terminal. Specifically, the error in the network may be corrected by a network manager manually and correct address configuration may be performed by the network manager manually.

The execution subject of the foregoing steps may be a network side, a DHCP server, or another device capable of sending a renumbering command in a network.

In the method for configuring an IP address provided by the embodiment of the present invention, when an address configuration policy conflict occurs in a terminal, a server generates an address configuration instruction or reports information about an error according to address configuration policy conflict information reported by the terminal, so that the address configuration policy conflict in the terminal is no longer processed by a local policy of the terminal, but processed by the server or a network management system. The server can decide what address configuration policy is adopted for the terminal, so as to provide an optimal solution for the conflict according to the actual situation of a network, and therefore, an adverse impact on the network caused by the conflict can be prevented.

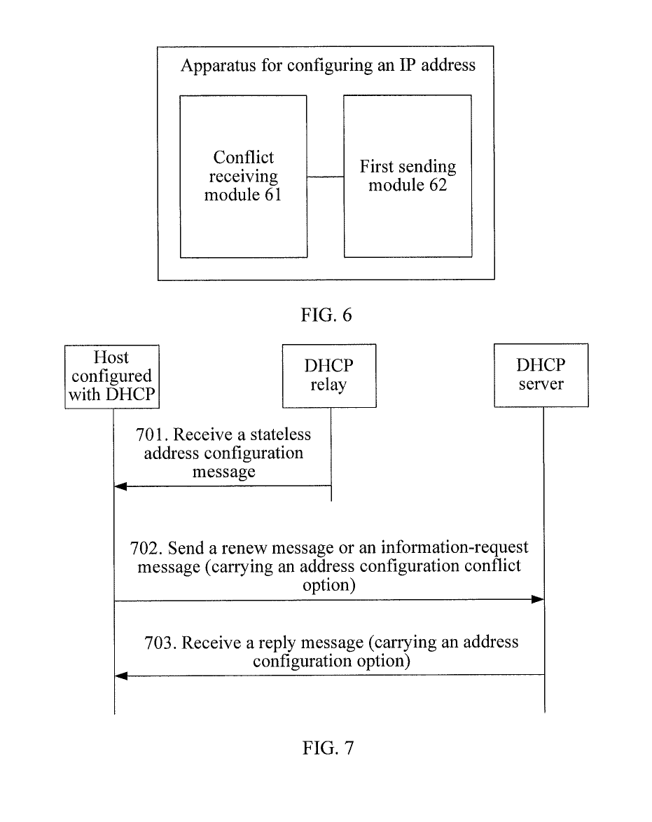

This embodiment further provides an apparatus for configuring an IP address. As shown in FIG. 6, the apparatus includes: a conflict receiving module 61, configured to receive address configuration policy conflict information reported by a terminal; and a first sending module 62, configured to, according to the address configuration policy conflict information, send an address configuration instruction to the terminal, or report information about an error to a network management system.

The method executed by the foregoing modules has been illustrated in detail above, and details are not described herein again.

In the apparatus for configuring an IP address provided by this embodiment, through a first sending module, when an address configuration policy conflict occurs in a terminal, a server generates an address configuration instruction or reports information about an error according to address configuration policy conflict information reported by the terminal, so that the address configuration policy conflict in the terminal is no longer processed by a local policy of the terminal, but processed by the server or a network management system. The server can decide what address configuration policy is adopted for the terminal, so as to provide an optimal solution for the conflict according to the actual situation of a network, and therefore, an adverse impact on the network caused by the conflict can be prevented.

### Embodiment 3

Taking a network including a host configured with DHCP, a DHCP relay and a DHCP server as an example, methods for configuring an IP address in three cases are illustrated in detail below with reference to FIG. 7 to FIG. 9, respectively.

FIG. 7 shows a method for configuring an IP address, and a host configured with DHCP, a DHCP relay (for example, a CPE: Customer Premise Equipment, customer premise equipment) and a DHCP server are disposed in FIG. 7. The method includes the following steps.

701: The host configured with DHCP receives a stateless address configuration message sent by the CPE, namely, an RA message.

At this time, an address configuration policy conflict may occur in the host configured with DHCP and served as the recipient of the RA message.

702: The host configured with DHCP sends a renew (renew) message or an information-request (information-request) message to report address configuration policy conflict information to the DHCP server.

The address configuration policy conflict information is included in an address configuration conflict option of the renew message or the information-request message. The address configuration conflict option is a new option defined in the request message, and the option is used to transfer address configuration policy conflict information of a host. The newly defined option is named as OPTION_IA_ReconfigConflict, and the format thereof is shown in the following table:

| | |
|---|---|
| OPTION_IA_ReconfigConflict | option-len |

IAID
IA_ReconfigConflict-options

In the table, the option-len indicates the length of the address configuration policy conflict information in the option, occupying a storage space of two 8-bit bytes, the IAID indicates an identifier of the option, occupying a storage space of four 8-bit bytes, and the IA_ReconfigConflict-options indicates the content of the address configuration policy conflict information, occupying a storage space of option-len*four 8-bit bytes.

The address configuration policy conflict information in the IA_ReconfigConflict-options may include, as required, the content that indicates the address configuration policy conflict, which may include a conflict type or conflict content, and may also include a conflict type and conflict content. The address configuration policy conflict information reported by the host shown in FIG. 7 may include a new address prefix delivered by the RA message.

703: The host configured with DHCP receives an address configuration instruction delivered by the DHCP server.

Specifically, the DHCP server delivers the address configuration instruction to the host through a reply (reply) message, in which the instruction is included in an address configuration option of the reply message. The option is a new option defined in the reply message, and the option is used to transfer host address configuration policy information of the DHCP server so as to instruct the host to perform address configuration in a specified manner.

A format of the address configuration option may be set as required, and the content of the address configuration instruction may also include different content according to a requirement of a network.

In the case shown in FIG. 7, the address configuration instruction may include content used to instruct the host to perform stateless address configuration according to the RA message, or include a new address allocated directly to the host, so that the DHCP server performs direct address configuration on the host.

For the case shown in FIG. 7, namely, when the host configured with DHCP receives only one stateless address configuration message, the DHCP server instructs address configuration of the host, thereby preventing a problem that a unified network policy may be violated when the host adopts a local policy to select stateless address configuration. The problem that, when the host adopts the local policy to select stateful address configuration, because the DHCP reconfiguration message is not received, the host may continue to use an old address and the renumbering of the host fails, can also be prevented.

It should be noted that, the method for reporting the address configuration policy conflict information is not limited to including the address configuration policy conflict information in the address configuration policy conflict option of the renew message or the information-request message, and the method may also be setting the address configuration policy conflict information in a new DHCP message, or setting the address configuration policy conflict information in an address configuration conflict option of a new DHCP message, or may be another method known by persons skilled in the art.

Similarly, the method for delivering the address configuration instruction is also not limited to including the address configuration instruction in the address configuration option of the reply message, and the method may also be setting the address configuration instruction in a new DHCP message, or setting the address configuration instruction in an address configuration option of a new DHCP message, or may be another method known by persons skilled in the art.

FIG. 8 shows another method for configuring an IP address. The method includes the following steps.

801: A host configured with DHCP receives a stateless address configuration message sent by a CPE, namely, an RA message.

At this time, an address configuration policy conflict may occur in the host configured with DHCP and served as the recipient of the RA message.

802: The host configured with DHCP receives a stateful address configuration message sent by a DHCP server, namely, a DHCP reconfiguration message.

803: The host configured with DHCP sends a renew (renew) message or an information-request (information-request) message to report address configuration policy conflict information to the DHCP server.

For the method for setting the address configuration policy conflict information, reference may be made to the setting method in FIG. 7. In the case shown in FIG. 8, because the host receives the address configuration messages of two protocol types, a case that new address prefixes carried in the two messages are inconsistent may occur, and the case belongs to a serious error. At this time, the content of the address configuration policy conflict information may include, but not limited to, a prefix conflict error identifier.

804: The DHCP server reports information about an error to a network management system.

When the DHCP server detects that the address configuration policy conflict information reported by the host includes the prefix conflict error identifier, the DHCP server reports information about an error to the network management system, and the network management system takes a corresponding measure to correct an error in a network, and implements a measure, such as performing correct address configuration on the host.

For the case shown in FIG. 8, namely, when the host configured with DHCP receives both a stateless address configuration message and a stateful address configuration message, through the corresponding operation of the DHCP server, a problem that the host may be possibly unable to perform routing when the host adopts a local policy is prevented.

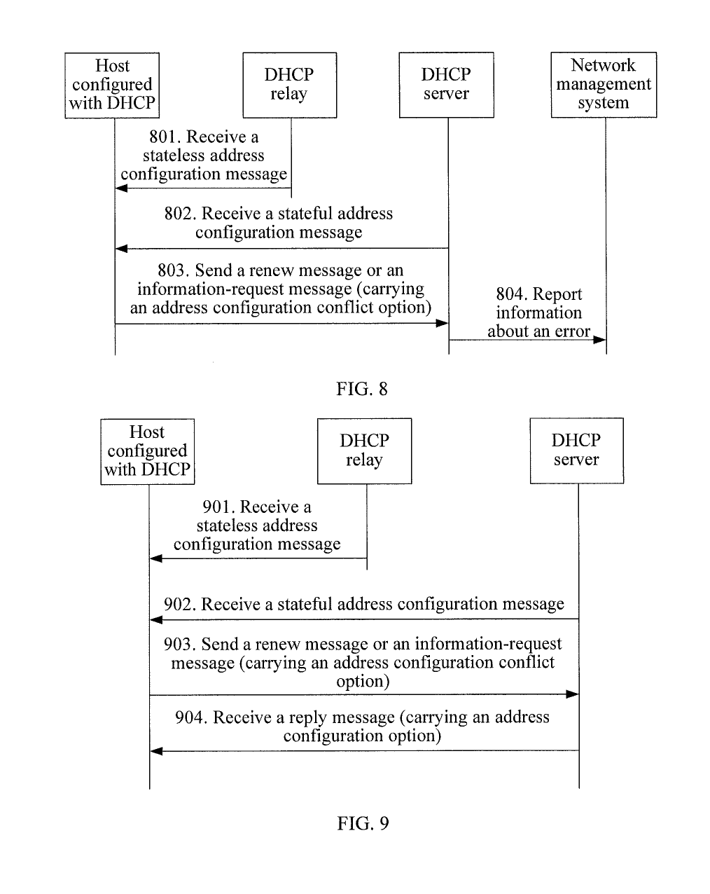

FIG. 9 shows still another method for configuring an IP address. The method includes the following steps.

901: A host configured with DHCP receives a stateless address configuration message sent by a CPE, namely, an RA message.

At this time, an address configuration policy conflict may occur in the host configured with DHCP and served as the recipient of the RA message.

902: The host configured with DHCP receives a stateful address configuration message sent by a DHCP server, namely, a DHCP reconfiguration message.

903: The host configured with DHCP sends a renew (renew) message or an information-request (information-request) message to report address configuration policy conflict information to the DHCP server.

For the method for setting the address configuration policy conflict information, reference may be made to the setting method in FIG. 7. The case shown in FIG. 9 is a complementary case of the case shown in FIG. 8, namely, the case that new address prefixes carried in the address configuration messages of two protocol types received by the host are consistent. In this case, the content of the address configuration policy conflict information may include new address prefixes delivered by the two messages.

904: The host configured with DHCP receives an address configuration instruction delivered by the DHCP server.

Specifically, the DHCP server may deliver the address configuration instruction to the host through a reply message, in which the instruction may be included in an address configuration option of the reply message, and the address configuration instruction may also be set in a new DHCP message. The address configuration instruction may instruct the host to perform address configuration in a specified manner.

The address configuration instruction may include content used to instruct the host to perform stateless address configuration according to the RA message, or content used to instruct the host to perform stateful address configuration according to the DHCP reconfiguration message, so that the DHCP server instructs the host to select a suitable address configuration manner.

For the case shown in FIG. 9, namely, when the host configured with DHCP receives both a stateless address configuration message and a stateful address configuration message, the DHCP server instructs address configuration of the host, thereby preventing a problem that a unified network policy may be violated when the host adopts a local policy to select stateless address configuration.

It can be learned through the foregoing detailed illustration of the methods for configuring an IP address in three cases that, in the method for configuring an IP address provided by this embodiment, when an address configuration policy conflict occurs in a host, a server generates an address configuration instruction or reports information about an error according to address configuration policy conflict information reported by the host, so that the address configuration policy conflict in the host is no longer processed by a local policy of the host, but processed by the server or a network management system. The server can decide what address configuration policy is adopted for the host, so as to provide an optimal solution for the conflict according to the actual situation of a network, and therefore, an adverse impact on the network caused by the conflict can be prevented.

### Embodiment 4

This embodiment provides an apparatus for configuring an IP address. The apparatus includes: a message receiving module, configured to receive an address configuration message; a conflict reporting module, configured to, when an address configuration policy conflict occurs, report address configuration policy conflict information to a network side; and an instruction receiving module, configured to receive an address configuration instruction delivered by the network side.

The conflict reporting module reports the address configuration policy conflict information to the network side in the following manner: the conflict reporting module reports the address configuration policy conflict information to a DHCP server through a DHCP message. The address configuration policy conflict information may be included in an address configuration conflict option (OPTION_IA_ReconfigConflict) of the DHCP message, in which the address configuration conflict option is used to transfer address configuration policy conflict information of a host.

The apparatus for configuring an IP address may be a terminal, a host configured with DHCP, or another device that needs to be renumbered in a network.

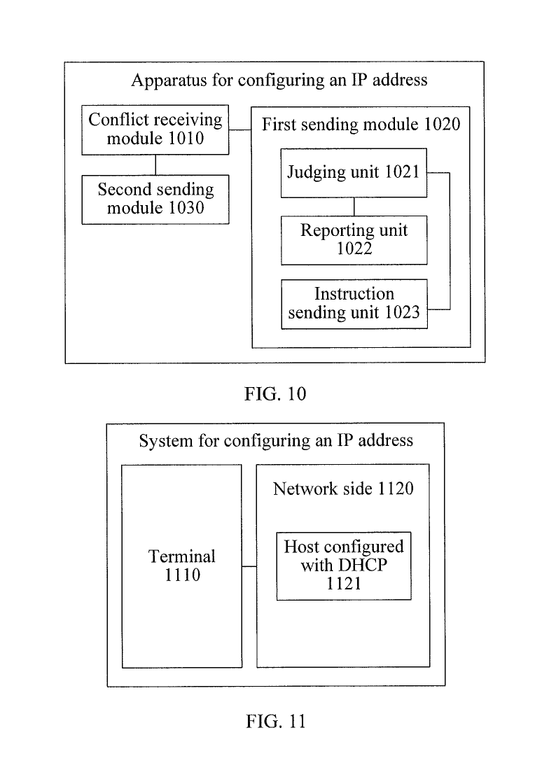

This embodiment further provides an apparatus for configuring an IP address. As shown in FIG. 10, the apparatus includes: a conflict receiving module 1010, configured to receive address configuration policy conflict information reported by a terminal; and a first sending module 1020, configured to, according to the address configuration policy conflict information, deliver an address configuration instruction to the terminal, or report information about an error to a network management system.

The apparatus may further include a second sending module 1030, configured to send an address configuration message to the terminal.

The first sending module includes: a determining unit 1021, configured to determine whether the address configuration policy conflict information includes a prefix conflict error identifier; a reporting unit 1022, configured to, when the determining unit 1021 determines that the address configuration policy conflict information includes the prefix conflict error identifier, report serious conflict information to the network management system according to the address configuration policy conflict information; and an instruction sending unit 1023, configured to, when the determining unit 1021 determines that the address configuration policy conflict information does not include the prefix conflict error identifier, send the address configuration instruction to the terminal.

Besides, the first sending module may send the address configuration instruction to the terminal in the following manner: the first sending module sends the address configuration instruction to the terminal through a DHCP message.

The address configuration instruction may be included in an address configuration option of the DHCP message, in which the address configuration option is used to transfer address configuration policy information of a host.

The apparatus for configuring an IP address may be a network side, a DHCP server, or another device capable of sending a renumbering command in a network.

The method executed by the foregoing modules has been illustrated in detail in Embodiment 3, and details are not described herein again.

In the apparatus for configuring an IP address provided by this embodiment, through a first sending module, when an address configuration policy conflict occurs in a terminal, a server generates an address configuration instruction or reports information about an error according to address configuration policy conflict information reported by the terminal, so that the address configuration policy conflict in the terminal is no longer processed by a local policy of the terminal, but processed by the server or a network management system. The server can decide what address configuration policy is adopted for the terminal, so as to provide an optimal solution for the conflict according to the actual situation of a network, and therefore, an adverse impact on the network caused by the conflict can be prevented.

### Embodiment 5

This embodiment provides a system for configuring an IP address. As shown in FIG. 11, the system includes: a terminal 1110 and a network side 1120, in which the terminal 1110 is configured to, when an address configuration policy conflict occurs, report address configuration policy conflict information to the network side 1120; and the network side 1120 is configured to, according to the address configuration policy conflict information, deliver an address configuration instruction to the terminal 1110, or report information about an error to a network management system.

The network side 1120 may include a DHCP server 1121, and the terminal 1110 is further configured to, when the address configuration policy conflict occurs, report the address configuration policy conflict information to the DHCP server 1121 through a DHCP message.

The address configuration policy conflict information may be included in an address configuration conflict option (OPTION_IA_ReconfigConflict) of the DHCP message, in which the address configuration conflict option is used to transfer address configuration policy conflict information of a host.

The DHCP server 1121 may be configured to, when the address configuration policy conflict information includes a prefix conflict error identifier, report the information about the error to the network management system according to the address configuration policy conflict information.

The DHCP server 1121 may also be configured to, when the address configuration policy conflict information does not include a prefix conflict error identifier, send the address configuration instruction to the terminal 1110 through a DHCP message according to the address configuration policy conflict information.

The address configuration instruction may be included in an address configuration option of the DHCP message, in which the address configuration option is used to transfer address configuration policy information of the host.

The method executed by the foregoing modules has been illustrated in detail in Embodiment 3, and details are not described herein again.

In the system for configuring an IP address provided by this embodiment, when an address configuration policy conflict occurs, a terminal reports address configuration policy conflict information to a network side, so that the address configuration policy conflict in the terminal is no longer processed by a local policy of the terminal, but processed by the network side, that is, the network side decides what address configuration policy is adopted for the terminal. Therefore, an optimal solution can be provided for the conflict according to the actual situation of a network, thereby preventing an adverse impact on the network caused by the conflict.

It should be noted that, the terminal is not limited to the host configured with DHCP described in each of the foregoing embodiments, and the address configuration policy conflict is also not limited to an address configuration policy conflict generated when the host configured with DHCP receives an RA message. For a host configured with ND, a conflict may also occur when the host configured with ND receives a DHCP reconfiguration message. In any network device that needs to be renumbered, as long as a protocol type of a received address configuration message is different from a protocol type configured by the device itself, namely, a conflict occurs and causes an adverse impact on a network, the conflict may be solved by using an embodiment of the present invention.

Through the above description of the embodiments, persons skilled in the art can clearly understand that the present invention may be accomplished by software plus necessary universal hardware, and of course, may also be accomplished by hardware, but in many cases, the former implementation manner is preferred. Based on such understanding, the technical solutions of the present invention essentially, or the part contributing to the prior art may be embodied in a form of a software product. The computer software product is stored in a readable storage medium, for example, a floppy disk, hard disk, or optical disk of a computer, and includes several instructions for instructing a computer device (which may be a personal computer, a server, a network device, or the like) to execute the method described in each of the embodiments of the present invention.

The embodiments of the present invention may be applied in a network deployed with multiple address configuration protocols.

The foregoing description is merely about exemplary embodiments of the present invention, but not intended to limit the protection scope of the present invention. Any variation or replacement readily apparent to persons skilled in the art within the technical scope disclosed by the present invention shall fall within the protection scope of the present invention. Therefore, the protection scope of the present invention shall be subject to the appended claims.

What is claimed is:

1. A method for configuring an IP address, comprising:
receiving an address configuration message;
when an address configuration policy conflict occurs, reporting address configuration policy conflict information to a network side; and
receiving an address configuration instruction delivered by the network side.

2. The method for configuring an IP address according to claim 1, wherein the reporting the address configuration policy conflict information to the network side comprises:
reporting the address configuration policy conflict information to a DHCP server through a DHCP message.

3. The method for configuring an IP address according to claim 2, wherein the address configuration policy conflict information is comprised in an address configuration conflict option (OPTION_{—} IA _ReconfigConflict) of the DHCP message, and the address configuration conflict option is used to transfer address configuration policy conflict information of a host.

4. The method for configuring an IP address according to claim 3, wherein the DHCP message is a renew (renew) message or an information-request (information-request) message.

5. The method for configuring an IP address according to claim 1, wherein the address configuration policy conflict information comprises a conflict type and/or conflict content.

6. A method for configuring an IP address, comprising:
receiving address configuration policy conflict information reported by a terminal; and
according to the address configuration policy conflict information, delivering an address configuration instruction to the terminal, or reporting information about an error to a network management system.

7. The method for configuring an IP address according to claim 6, wherein before the receiving the address configuration policy conflict information reported by the terminal, the method further comprises sending an address configuration message to the terminal; and
reporting the information about the error to the network management system according to the address configuration policy conflict information, when the address configuration policy conflict information comprises a prefix conflict error identifier.

8. The method for configuring an IP address according to claim 6, wherein when the address configuration policy conflict information does not comprise a prefix conflict error identifier, the address configuration instruction is sent to the terminal according to the address configuration policy conflict information.

9. The method for configuring an IP address according to claim 6, wherein the sending the address configuration instruction to the terminal according to the address configuration policy conflict information comprises:
sending the address configuration instruction to the terminal through a DHCP message.

10. The method for configuring an IP address according to claim 9, wherein the address configuration instruction is comprised in an address configuration option of the DHCP message, and the address configuration option is used to transfer address configuration policy information of a host.

11. The method for configuring an IP address according to claim 10, wherein the DHCP message is a reply (reply) message.

12. The method for configuring an IP address according to claim 6, wherein the address configuration instruction comprises: selecting stateless address configuration, or selecting stateful address configuration, or directly allocating a new address.

13. An apparatus for configuring an IP address, comprising:
a message receiving module, configured to receive an address configuration message;
a conflict reporting module, configured to, when an address configuration policy conflict occurs, report address configuration policy conflict information to a network side; and
an instruction receiving module, configured to receive an address configuration instruction delivered by the network side.

14. The apparatus for configuring an IP address according to claim 13, wherein the conflict reporting module reports the address configuration policy conflict information to the network side in the following manner:
the conflict reporting module reports the address configuration policy conflict information to a DHCP server through a DHCP message.

15. The apparatus for configuring an IP address according to claim 14, wherein the address configuration policy conflict information is comprised in an address configuration conflict option (OPTION_IA_ReconfigConflict) of the DHCP message, and the address configuration conflict option is used to transfer address configuration policy conflict information of a host.

16. An apparatus for configuring an IP address, comprising:
a conflict receiving module, configured to receive address configuration policy conflict information reported by a terminal; and
a first sending module, configured to, according to the address configuration policy conflict information, deliver an address configuration instruction to the terminal, or report information about an error to a network management system.

17. The apparatus for configuring an IP address according to claim 16, further comprising:
a second sending module, configured to send an address configuration message to the terminal, wherein
the first sending module comprises:
a determining unit, configured to determine whether the address configuration policy conflict information comprises a prefix conflict error identifier;
a reporting unit, configured to, when the determining unit determines that the address configuration policy conflict information comprises the prefix conflict error identifier, report serious conflict information to the network management system according to the address configuration policy conflict information; and
an instruction sending unit, configured to, when the determining unit determines that the address configuration policy conflict information does not comprise the prefix conflict error identifier, send the address configuration instruction to the terminal.

18. The apparatus for configuring an IP address according to claim 16, wherein the first sending module sends the address configuration instruction to the terminal in the following manner:
the first sending module sends the address configuration instruction to the terminal through a DHCP message.

19. The apparatus for configuring an IP address according to claim 18, wherein the address configuration instruction is comprised in an address configuration option of the DHCP message, and the address configuration option is used to transfer address configuration policy information of a host.

20. A system for configuring an IP address, comprising a terminal and a network side, wherein
the terminal is configured to, when an address configuration policy conflict occurs, report address configuration policy conflict information to the network side; and
the network side is configured to, according to the address configuration policy conflict information, deliver an address configuration instruction to the terminal, or report information about an error to a network management system.
